(19) United States
(12) Patent Application Publication
(10) Pub. No.: US 2002/0069186 A1
(43) Pub. Date: Jun. 6, 2002

(54) System and method for postal presort analysis

(76) Inventor: Peter Moore, Boulder, CO (US)

Correspondence Address: Roberts Abokhair & Mardula, L.L.C., Suite 1000, 11800 Sunrise Valley Drive, Reston, VA, 20191-5302, US

(21) Appl. No.: 09/812,507

(22) Filed: Mar. 20, 2001

Related U.S. Application Data
(60) Provisional application No. 60/238,651, filed on Oct. 6, 2000.

(51) Int. Cl. G07B 17/02

(52) U.S. Cl. 705/401

(57) ABSTRACT

A system and method for applying presort modeling to a mailing. A pre-existing database from a previously run, commercially available presort program is used. The system and method use one or more alternative option sets. Option sets are created from user input of parameters. The system and method permit the user to test alternate parameters by deriving a unique presort mailing and resultant costs and other effects for each option set considered. Resultant costs and other effects are displayed on a monitor or may be exported to a spreadsheet. The presentation format allows the user to readily compare alternatives. This lets the user arrive at an efficient, optimal presort mailing solution consistent with the user's priorities. Additionally, presort strategies outside of USPS regulations may be tested and used in negotiation with the USPS for alternate rate terms.

### CROSS REFERENCE TO RELATED APPLICATIONS

This application claims priority under 35 U.S.C. §119(e) from provisional application number 60/238,651, filed Oct. 7, 2000. The 60/238,651 provisional application is incorporated by reference herein, in its entirety, for all purposes.

### FIELD OF INVENTION

This invention relates generally to postal presort mailings. Specifically, the present invention is a system and method for evaluating presort options (parameters) so as to optimize the presort strategy. Revised Mail.dat, parameter file, Resequenced Label file, and cost and statistical data reports are byproducts of the strategy analysis.

### BACKGROUND OF THE INVENTION

USPS allows bulk mailers a discount for presorting the mail. There are multiple ways a mailing may be presorted. Postal distribution of mail is accomplished via a complex network comprising carrier routes, delivery units (generally represented by ZIP Codes), 3-digit ZIP Code offices (1st 3 digits of the ZIP), Sectional Center Facilities (abbreviated “SCF” and referring to larger offices serving one or more 3-digit ZIPs), Area Distribution Centers (“ADC”—serving multiple SCFs), and other, higher level offices, such as Auxiliary Service Facilities (“ASF”) and Bulk Mail Centers (“BMC”). These distribution types are known as presort levels.

In order to qualify for favorable mailing rates (i.e., other than First-Class), mailings must be prepared to meet USPS distribution specifications. Detailed regulations are published and continually updated by the USPS.

How mail is presorted has a major impact on mail preparation costs, delivery time, postage, and USPS costs. Mailing can be presented by piece or package and in containers such as trays, sacks and pallets. Presort information relates the number and type of containers, their weights and numbers of pieces in a presorted mailing.

An industry standard database is known as Mail.dat. Mail.dat is a database describing a mailing in a format of a collection of files The Graphic Communications Association (GCA) administers the format specification. This uniform specification allows users to send and receive information about mailings without translating the proprietary formatting specifications of presort software vendors.

The current standard, GCA Standard 130-1995 version 98-2, is a collection of up to nineteen files, each file containing different views of the data. There are linkages from each file to at least one other file within the database. The files are in ASCII format, but constitute a logical, relational database. Mail.dat contains everything about a mailing except names and addresses. Mail.dat is used to communicate the specifics of a mailing among the participants in the process, including the USPS.

There are presort programs available that automate the presort process so as to qualify for USPS presort status. Mail is collected into packages and packages are then collected in containers. Each container is labeled. The output of a presort typically consists of postal reports, a name and address label file (or printed labels), and, optionally, a Mail.dat file set that represents the results. The thresholds at which a sack or pallet may be prepared and the minimum and maximum that may be placed in a container are, in substantial measure, at the mailer's discretion. Further, there are alternative sort rules that the mailer may choose to use if they prove advantageous.

Usually, presort parameters are set by the mail owner well in advance of a mailing. Often, the parameters are not changed particularly for periodicals, which tend to have similar but not identical characteristics from mailing to mailing. All too frequently, the parameters are set without knowing the consequences of the choices made. Manipulation of presort variables (minimums, maximums, use of optional levels, preparation under alternative rules, etc.) can have a dramatic effect on the number, and level, of containers created.

The presort strategy affects postage cost, USPS cost, mail preparation (handling costs), location of mailing, delivery time and delivery condition. Trade offs as to mailing objectives and costs have to be made. For instance, a publisher of a weekly news magazine might be willing to incur additional production or postage costs to attain delivery goals, whereas the mailer of a catalog could consider cost paramount. Thus, there is no one “right” way. However, for each mailing, a consideration of all the factors can result in an optimal balance.

The USPS is becoming aware that there can be a substantial discrepancy between their costs and revenues (postage). For instance, mailers can perform two perfectly legal presorts of the same mailing, one of which is twice as costly for the USPS to handle as the other. Partly as a consequence, the USPS is planning on developing Negotiated Service Agreements (“NSA”) and “Niche Classifications” that may offer advantages to those mailers willing to prepare the mail more efficiently. However, there is no present way to easily model these costs for different preparation options. Further, there is no way to determine the overall impact of selecting one set of presort variables over another set and no way of re-sequencing the analyzed mailing to conform to the selected options set.

Presort programs incorporate USPS regulations in the analysis, limiting options and parameters to those adopted regulations. These programs do not allow the mailer or the USPS to analyze optimum strategies that go outside the regulations. Alternative rate considerations and parameter categories such as new delivery levels will not be analyzed.

As mentioned above, presort programs are commercially available. Following is brief descriptions of the logic of a portion of a hypothetical presort program that might be used where the containers are pallets and sacks and the container items are packages. Overall, the presort program's objective is to make a container at the finest level possible. The algorithm's objective is to sort packages by container type and at various USPS delivery levels. This process is current art in the industry and is presented for informational purposes.

Prior to start of this algorithm, a different algorithm captures the parameters and options that are to be used. For example, using a graphical user interface (GUI), the user may opt to include pallets as one of the container types to be considered. Further, the user may decide that the pallets should not contain less than 250 pounds nor more than 2000 pounds for the five-digit zip code level. These options and parameters, along with a host of other options and parameters, are captured and stored in a configuration set file. At the start of our hypothetical algorithm, the configuration set is read and the values stored in memory.

The process determines if the user wants to have palletization done. Again, this option is part of the configuration set and the information is stored in memory. Assuming that pallets are to be used, the process checks the current sort level being processed. Reiterating, a sort level is a postal service mail grouping such as an office building, an individual carrier, a five-digit zip code, etc. The process checks to make sure the configuration allows sorting at this level. Assuming the user wants to use the current level, the package (a collection of individual mail pieces) is aggregated at the current level. That is, the weight of the package is added to a running total of weight for the particular pallet within a given level. Note that the weights of each package have previously been determined and stored in memory.

If the aggregated weight meets or exceeds a maximum amount, the process contains logic to close up that pallet. The individual packages to be included in that pallet are so marked. If a package causes the aggregated weight to exceed the maximum, that package is reserved for the next pallet. Assignment of the finished pallet is made to the current level, but only if more pallets are assignable to the current level. If the finished pallet is not assignable to the current level, the process determines if there are more levels available. If there are more levels available, the current level is incremented to the next available level. Thus, the program's objective is to make a container at the finest level possible, so the user will normally opt for a large number of pallets at the lowest USPS level. If there are no more levels, the packages not assigned to pallet containers are analyzed for inclusion in a different container type.

If the maximum weight for the pallet has not been reached, the next package, as stored in memory, is processed. This next package is aggregated and a check is again made to determine if a maximum weight has been met or exceeded. Once the aggregated weight meets or exceeds the maximum amount for a pallet, the pallet is closed as was discussed above. If all packages to be processed have been considered and the aggregate weight is at least equal to the minimum weight for the pallet, the pallet is closed and the individual packages are marked as belonging to that pallet. If minimum weight has not been achieved, the packages are earmarked for the next container analysis, which is, in this case, the sack container.

The sacking process logic is employed once the palletization process has been finished either because: accumulation of more pallets would exceed the number of pallets parameter; or there are packages unassigned to pallets. Each package is processed sequentially. The process checks to make sure that sorting is valid for the current postal service level. If it is, the package count is incremented. The count is tested to see if it has reached a maximum count value. Once maximum count level is achieved, the sack is closed and the packages are marked as belonging to the current sack. If there are more sacks that can be allocated to the current level, a new sack is started and the next package is processed.

If no more sacks may be allocated to the current level, the postal level is incremented to the next valid level as established by the configuration set. Again, individual packages are processed in a sequential fashion until all sacks are exhausted. At this point the ‘sacking’ algorithm is stopped. If the process ends because all the packages have been considered, a sack is completed if the minimum number of packages per sack parameter has been achieved. Otherwise, the individual packages are marked as non-containerized packages.

Currently, it is possible to repetitively run existing presort programs to try out different options. However, there are a number of problems with this approach:

a) Presort software output analysis is insufficient. The presort software may have reports that tell the number of containers produced, but not the ramifications pertaining to postal costs or delivery.

b) Presort software is usually a part of a production process, leaving limited opportunity to use it for analysis. Often these programs have significant overhead and costs associated with their use. Cost may be a deterrent to further analysis.

c) Presort is often run at a service bureau, using estimated weights and other values, long before the actual mailing is to take place.

d) There is no mechanism for modifying the sequence to reflect the selected options once the presort has been run.

e) There is no ability to analyze presort mailing proposals that lie outside current USPS regulations.

What is required is a program that provides analyses of presort costs and delivery impacts given different option sets. In this fashion, the mailer can perform tradeoffs between costs, delivery and handling. Note, the terms ‘option set’ and ‘configuration set’ are used interchangeably. Additional output would include a Resequenced Label file as well as a formatted parameter file for future presort iterations.

### SUMMARY OF THE INVENTION

It is therefore an objective of the present invention to allow the user to model and analyze presort mailings by importing a previously prepared database (Mail.dat) and by using one or more option sets for that mailing.

It is another objective of the present invention to sort and containerize packages of a presort mailing where said packages were composed by a prior presort preparation.

It is a further objective of the present invention to project postage, USPS costs, production costs and delivery factors using the parameters provided by the user.

It is yet another objective of the present invention to allow the user to extract the option set that was used in the imported previously prepared database, Mail.dat.

It is a further objective of the present invention to allow the user to analyze and combine mailings such that the multiple mailings share common containers such as pallets.

It is a further objective of the present invention to create a parameter file that can be used as input for subsequent presorts analyses.

It is a further objective of the present invention to create a new Mail.dat database that reflects the optimum presort results.

It is a further objective of the present invention to create a revised name and address label file that reflects the optimum presort sequencing as selected by the user.

It is yet another objective of the present invention to provide a facility for analyzing the effect of performing presort using different parameters as measured by delivery, postal cost, postage, production costs.

It is another objective of the present invention to allow analysis of presort proposals not provided for within USPS regulations.

It is yet another objective to calculate a presort strategy figure of merit that rates a particular option set's effectiveness relative to an optimum strategy.

The present invention is a system and method that allows rapid and easy modeling of presort results by varying objectives and parameters. Output will include postage, USPS costs, mail handling and delivery impacts, database set (Mail.dat), Resequenced Label file and parameter file reflecting the presort criteria. Availability of USPS costs is significant in that negotiations for NSA or Niche Classification contracts will be easier if the USPS benefits are demonstrated.

The Presort Analyzer of the present invention uses a Mail.dat database created in a previously executed presort. The prior presort is accomplished by running a commercially available program used by the Presort mailing industry. The input for the prior presort includes a mailing list containing names and addresses and a parameter or job file that identifies those options that are to be used. The Mail.dat database is imported by the Presort Analyzer. The user inputs one or more option sets. An interface is used to identify option sets to be used. In the present embodiment, the interface is a GUI. The output of the present invention is a summary of costs, handling impacts and mail statistics. If multiple option sets are used the costs and mail statistics are presented in a side-by-side form so that the user may easily compare alternative strategies. One embodiment of the present invention allows the user to export the results to a spreadsheet for further analysis.

Another feature of the present invention allows the user to extract the option set that was used in the imported previously prepared database, Mail.dat.

The user may also perform an analysis in order to combine mailings so as to take advantage of more efficient containerization, particularly pallets.

A further feature of the Presort Analyzer is that the user may import name and address files associated with one or more imported Mail.dat databases and a sequenced or re-sequenced name and address label file will be produced. This feature is particularly useful for last minute modification of the presort mailing.

Still another feature of the present invention is to provide a Job File. A job file is an option set that is cast in a format required by a specific, commercially available presort program. This job file is created from the option set chosen by the user as the optimum option set. The job file can be used in future exercises of presort mailing analyses. The user (or agent) thus does not have to compose a new job file.

Another feature of the present invention is the generation of a “figure of merit”, that is an efficiency rating score associated with a specific option set. This figure can be made available as needed to an entity proposing a specific mailing scheme.

The ability to incorporate actual values as opposed to estimated values in the presort analysis is still another feature of the present invention. For example, the weight of a mail piece such as a magazine may be estimated because the weight is not known until the actual printing. Also, the percentage of advertising, another factor in presort postage calculation, is generally estimated and is unknown until the periodical is ready to be printed. Also the original mailing location (such as the printing plant) is usually not specified in the mail.dat. The Presort Analyzer, run just before mailing, can use the actual values, thus improving the accuracy of the analysis and calculation of postage. All of these characteristics of the present invention in the aggregate yield a highly advantageous method of analyzing presort.

### BRIEF DESCRIPTION OF THE DRAWINGS

FIG. 1 illustrates a schematic representation of the Presort Analyzer in accordance with one embodiment of the invention.

FIG. 2 illustrates the process flow of the present invention.

FIG. 3 illustrates the analysis function of the present invention.

FIG. 4 illustrates a data collection GUI of the present invention.

FIG. 5 is a sample set of reports output in the analysis step in accordance with one embodiment of the invention.

FIG. 6 is a sample set of reports output in the analysis step in accordance with one embodiment of the invention. This analysis reflects a different option set than what was used for the sample set of reports in FIG. 5.

### DETAILED DESCRIPTION OF THE INVENTION

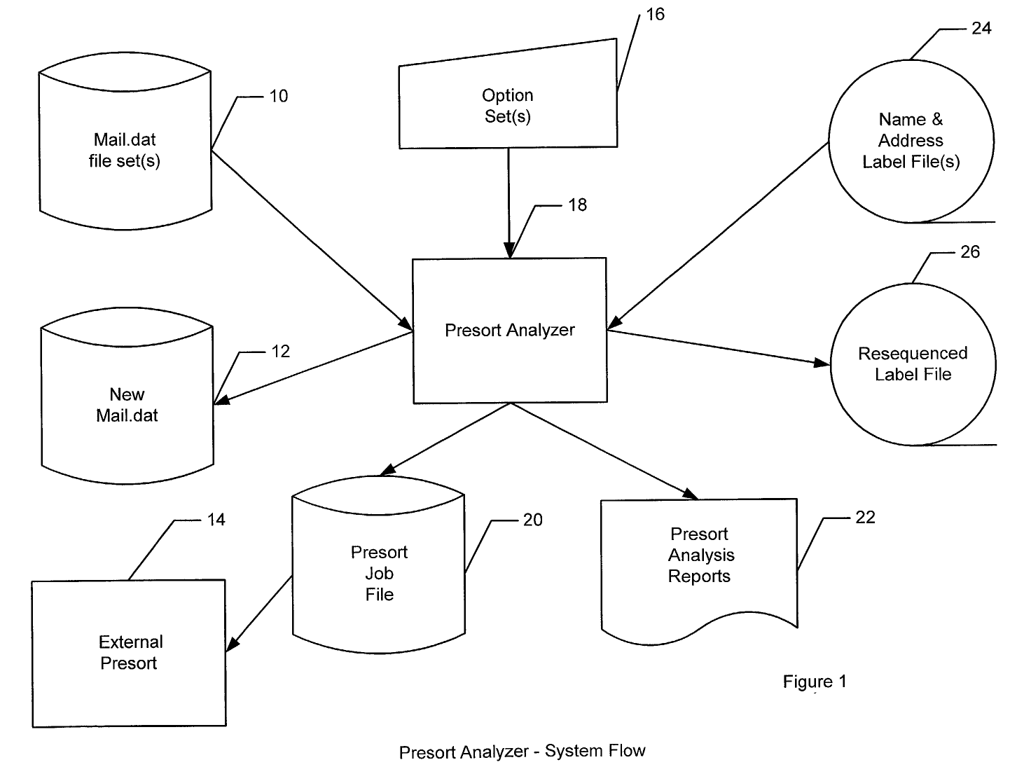

Referring to FIG. 1 a schematic representation of the Presort Analyzer in accordance with one embodiment of the invention is illustrated. The user imports database Mail.dat 10 that was previously produced by a presort program. Mail.dat is the Presort mailing industry standard for formatting mailing records. The Graphic Communications Association (GCA) administers the format specification. This uniform specification allows users to send and receive information about mailings without translating the proprietary formatting specifications of presort software vendors.

The user may input one or more Option Sets 16 via a user interface. These options directly affect presorts. The Presort Analyzer 18 imports and parses the Mail.dat file set along with any Option Sets 16 and generates a Presort Analysis Report 22.

The presort analysis report indicates the amount of postage, the costs to USPS, production costs and estimated delivery time factor that can be used to assess the impact on delivery. Piece count, per piece statistics, number of packages, and number and types of containers used is also part of the analysis. If multiple Option Sets are used, the report displays the results for each option in an easy to view form. The analysis' presentation allows ready comparison of the results. One embodiment of the present invention exports the report to a spreadsheet. An alternate embodiment displays the results on a computer display.

The Presort Analyzer 18 also produces a Presort Job File 20 on demand. This job file is a parameter file cast in form suitable for a specific presort program commercially available. The user may select the format of the Job File to be generated by selecting from a menu of commercially available presort programs. The user also selects one option set from alternative option sets considered.

The Presort Job File 20 can then be used by a specific presort program to generate an External Presort 14. This job file can be used for future analyses as required.

The Presort Analyzer 18 performs a presort of the mailing characterized by Mail.dat. The options used in the presort are input by the user. An option set that is implicit in the imported Mail.dat, can be derived from the original Mail.dat file set. Therefore the parameters that were used in the original presort are derivable from the original Mail.dat. The user may input additional Option Sets 16. The resultant New Mail.dat 12 suitable for USPS needs is available on demand. The New Mail.dat 12 reflects the Option Set chosen.

If more than one Mail.dat file set 10 is used for combined mailing analysis and presort, then the New Mail.dat 12 will reflect the combined inputs.

The Presort Analyzer also has the ability to import Name and Address Label Files 24 and produce a re-sequenced set of name and address labels in the Resequenced Label File 26. Name and Address Label Files contains name and address entries for each recipient of mail in a form sufficient to print an address label for each mail piece or package. Further, the name and address entries are sorted in the order that the mail is to be delivered after a presort analysis is run.

This allows the mailer to perform last minute manipulations and still have the ability to rapidly print the address on labels, mail pieces or packages via ink-jet or other ways known in the art that match up with the ultimate sequence of mail pieces in the presort.

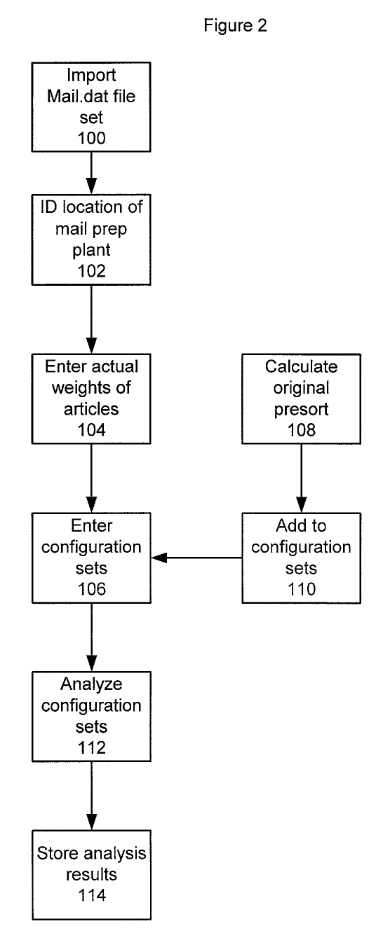

Referring to FIG. 2, the presort analyzer process is illustrated. The user starts by importing one or more Mail.dat file sets 100 that represent the mailings that the user wishes to analyze. This creates a working database and serves as a baseline for calculations against which further analysis can be conducted. The presort analyzer also allows the user to identify the location of the mail preparation plant (printer or lettershop) 102. This information has a significant bearing on future calculations, in particular postal costs. The user may subsequently revise this origin information in the analyzer (as noted below) in order to achieve more accurate results.

The preliminary presort is often run with estimated weights and, for periodicals, advertising percentages. Since the production mailing piece can often differ significantly from the initial estimates, it is necessary to revise these numbers to accurately reflect the finished product. For example, the printed copy of a magazine often departs considerable in weight and advertising percentage from the initial estimates. Since these values are used in the preparation of containers and calculations of postage, the program provides a means for the user to enter the actual values 104.

The user must specify one or more sets of presort variables to be used in the analysis 106. These option sets are also known as “configuration sets.” Each configuration set specifies container minimums and maximums for each presort level (carrier route, Delivery unit, SCF, ADC, etc.), whether or not optional presort levels are to be used, whether or not optional palletization or copalletization (the combining of packages from multiple mailings onto common pallets) is to be performed, and whether or not optional presort rules are to be utilized.

Very often, the actual parameters that used to perform the presort that were implicitly imported with Mail.dat are unknown to the person or company performing the analysis. Thus the program provides a function that analyzes the Mail.dat file set to determine the values (option set) used 108. It adds this calculated production configuration set to the other configuration sets 110. This deduced set is used to provide a benchmark against which other sets may be measured.

After an analysis step 112, the program allows the user to save and restore configuration sets. This allows the user to repeat a standard set of analyses, to alternate among different sets according to specific mailing characteristics (e.g., large file vs. small file), or to save their work for later resumption.

Analysis results can be exported to a spreadsheet or otherwise stored 114. These results may be compared with other configuration sets' results and/or archived.

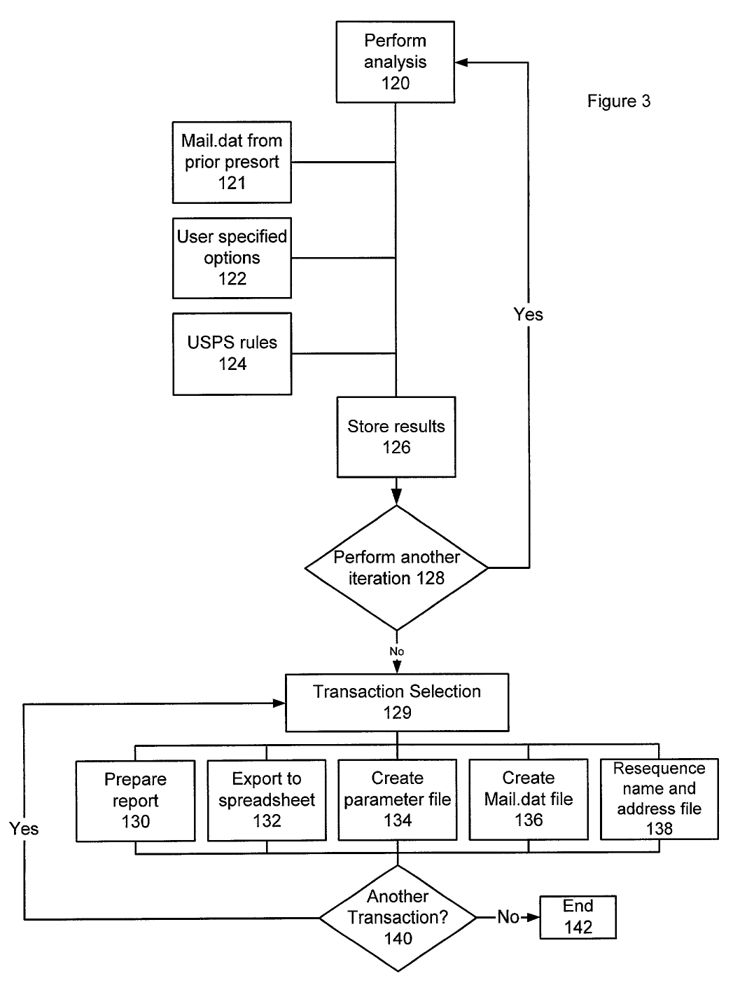

Referring to FIG. 3 the analysis function is further illustrated. The analysis performed by the present invention 120 starts performing the presorts according to the data contained in the database, Mail.dat file set 121, options that the user has specified 122 and considering USPS rules 124. The results are stored 126. Unlike conventional presorts that work with individual name and address records, this program works with the summarized package-level data in the Mail.dat file set. Since USPS package make-up rules do not contain many options, the program is able to ignore package preparation and concentrate on container preparation, where considerable variation occurs.

As previously noted in the Background section, the presort program's objective is to make a container at the finest level possible. The general logic for a presort is as follows. If the amount of mail at a presort level meets or exceeds the minimum weights or counts specified in the presort parameters, a container will be prepared. If there is insufficient mail to prepare a container at one level, the program will attempt the next level, until all packages have been assigned to a container.

For example, a configuration might call for making pallets for 5-digit ZIP Codes to which a minimum of 250 pounds is being sent, then skipping 3-digit pallets (an optional level), then SCF pallets with a minimum of 500 pounds, then ADC pallets with a minimum of 250 pounds, and then sacks with a minimum of 24 copies at each level. The program would make 5-digit pallets for all ZIP Codes that had at least 250 pounds of mail destined to them. Mail for ZIP Codes with less than 250 pounds would be rolled up to the SCF level, at which point, SCF pallets would be specified for all SCFs to which a minimum of 500 pounds of mail was being sent. Unallocated packages would then become candidates for the ADC sort. ADC pallets would be prepared for each ADC to which at least 250 pounds of mail was destined. The program would then start trying to assign unallocated packages to sacks, again, starting from the finest level possible.

The program performs as many iterations 128 of the presort as the user has requested, once for each set of presort parameters in the configuration sets, storing the results 126 in an interim database.

In order to calculate the postal costs, published cost data is used. This includes cost per piece, cost per package, and cost per container for each presort level and type of container, by entry level.

Calculation of the delivery impact of each presort configuration set is based on the additional handling of a package that results from putting it in a container that is prepared at a coarser level than the package itself. For instance, it is probable that a carrier route package placed in a carrier routes sack will receive the most expeditious handling possible. If, in a different presort, the same carrier route package were to be placed in an ADC sack (ADCs serve thousands of ZIP Codes), it is likely that several additional days would be required for that package to reach the hands of the carrier who was to deliver the mail therein. A delivery factor is calculated by determining the additional days required to move each package to the point at which it would receive optimal delivery, multiplying that by the number pieces in the package, summing those results for all the packages, and dividing by the number of pieces in the mailing. This provides, not an estimate of actual delivery, but an index by which one can assess the impact that one presort configuration set has on delivery, contrasted with other analyzed sets. Thus the delivery metric is used to help a user judge the effectiveness of presort as expressed in terms of postal processing cost, postage, delivery and production costs. The metric is not an absolute number but is a relative term that takes delivery issues into account. In general the resulting delivery number is an indicia of the relative delivery efficiency. The lower the value, the better the delivery. If delivery is the primary consideration of a presort mailing, the optimum presort strategy is the one yielding the lowest delivery factor. Thus the delivery factor is an index to which a given mailing departs from a theoretical optimum.

When all iterations have been performed, a selection of a transaction occurs 129. A report may be created 130 showing the results of the analysis. The present invention allows the user to select to have the results exported in spreadsheet format 132 for additional manipulation. The results may also be viewed on a display. Alternatively, the program allows the user to set up future presort jobs to run in conformance with the selected parameters. Many presorts allow parameters and options to be the input by a Job File. In the present invention, the user may choose the configuration set to be used to perform subsequent presorts, specify the format of the parameter file (based on the particular product that will be used).

Another possible transaction of the present invention is to create a parameter file in the appropriate format 134. For example, if the Acme Presort program is to be used to perform subsequent presorts, the user could request that the present invention create a parameter file that would be read by the Acme Presort program. Subsequently, the user could run Acme Presort in accordance with the presort parameters in the selected configuration set.

Once the user has determined which is the optimal configuration for the user's needs, the user may choose to create a new Mail.dat file set 136 summarizing the results of using that set of parameters. The program creates this by processing the input file set against the configuration parameters selected and the working database used to perform the analysis. In general, the PackageQuantity file would, be re-created to reflect the new containers into which the packages should be placed. Other files in the set, such as the Header, ContainerQuantity, ContainerLabel, and ContainerSummary files would be built from the new PackageQuantity, the MailPieceUnit, and the Component files. The output conforms to the current version of the Mail.dat standard.

Once a configuration set has been chosen, another transaction selection of the present invention allows the user to specify that the original name and address label file be re-sequenced 138 to match that configuration. The user specifies the format of the input label file, the format of the output label file, and the presort configuration set containing the parameters by which it should be re-sorted.

The program builds a cross-reference of the original values for package and container codes. For example, package 1 in container 1 (an ADC pallet) might have moved to container 64 (a 5-digit pallet). In the output file (and the Mail.dat) the ContainerID field in the PackageQuantity file would point to this new container 64. The logic is similar to, and should be performed in conjunction with, the production of a new Mail.dat file set. The input name and address file is read and an output file is created in the specified format, containing the correct codes and in the correct sequence.

After each transaction selection has been run, the present invention checks if any other transactions 140 are required. If so, the transaction selection 129 process is re-entered and a transaction is executed. If no more transactions are required the program terminates 142.

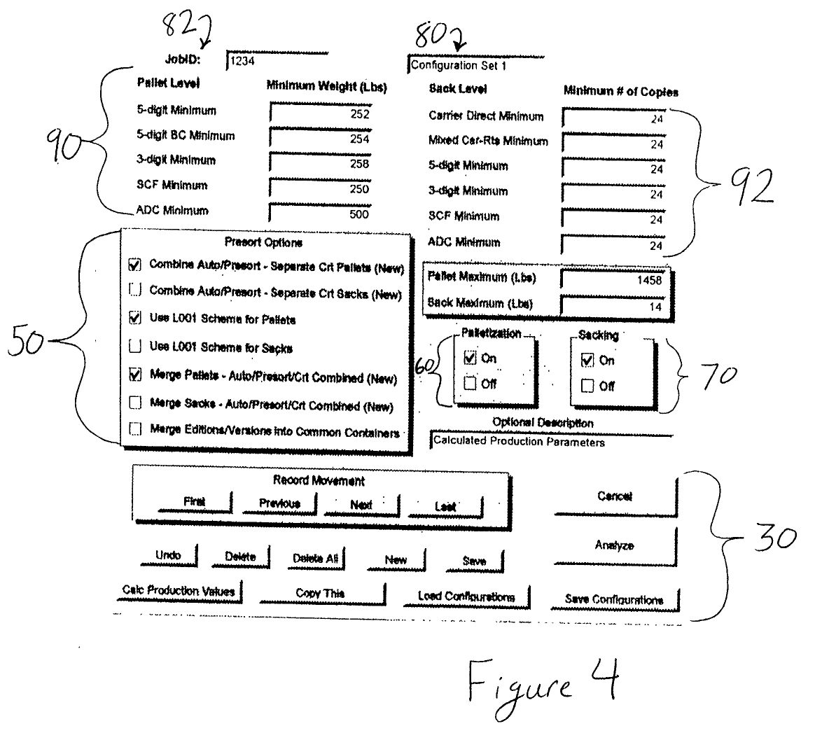

Referring to FIG. 4, a sample GUI allowing a user to build a configuration set is illustrated. The particular set is “Configuration Set 1” 80. The JobID 82, identifies the particular job. Pallet Level 90 lists five different presort levels, for which the user must fill in minimum weights to be used in this sample presort. The sample GUI lists six Sack Level 92 entries, and the filled in values are minimum number of copies (pieces). Presort Option 50 is a collection of seven check boxes that provides options such as “Scheme for pallets”. Pallet Maximum and Sack Maximum 52 are additional GUI fields that allow the user to provide weight parameters. The user inputs the binary value of Palletization “On” or “Off” 60 via a mutually exclusive pair of check boxes. Similar input mode is provided for Sacking on or Sacking Off 70. A collection of action directives 30 such as Cancel, Analyze, Save Configuration, etc. is also provided.

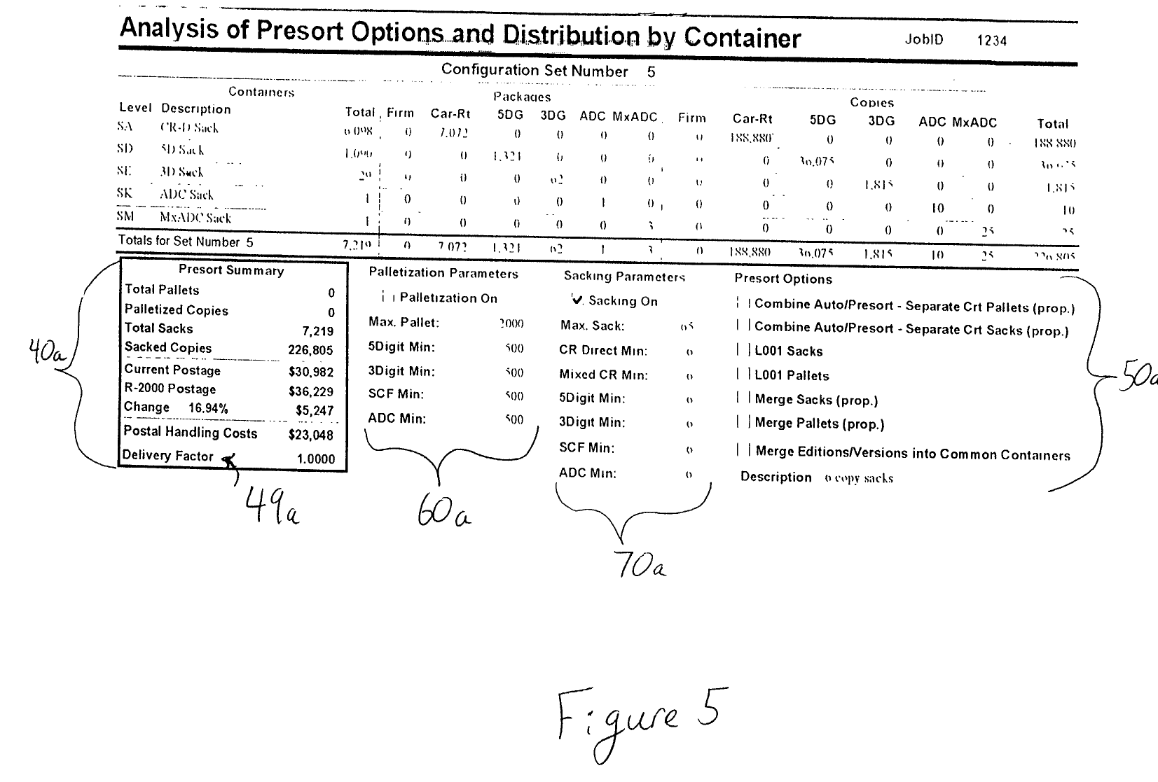

Referring to FIG. 5 a sample set of analysis output reports, in accordance with one embodiment of the present invention, is illustrated. This sample report contains statistics regarding containerization by presort level as well as by piece (copy) and by package. Note that options and parameters for this sample set of reports derive from the inputs shown in FIG. 4.

The relevant data are “Presort Summary” 40a, “Presort Options” 50a, “Palletization On” check box 60a and “Sacking On” check box 70a. “Configuration Set Number” 80a identifies this configuration set as the set input by the user via the GUI as noted in FIG. 4.

This Presort Summary indicates that there is a “Delivery Factor” 49a of 1.3977. As previously discussed, the delivery factor in an index of how much handling a package or copy undergoes. All other things being equal, a lower delivery factor is desirable. The mailer should be willing to pay more to get a lower delivery factor if delivery time is a high priority.

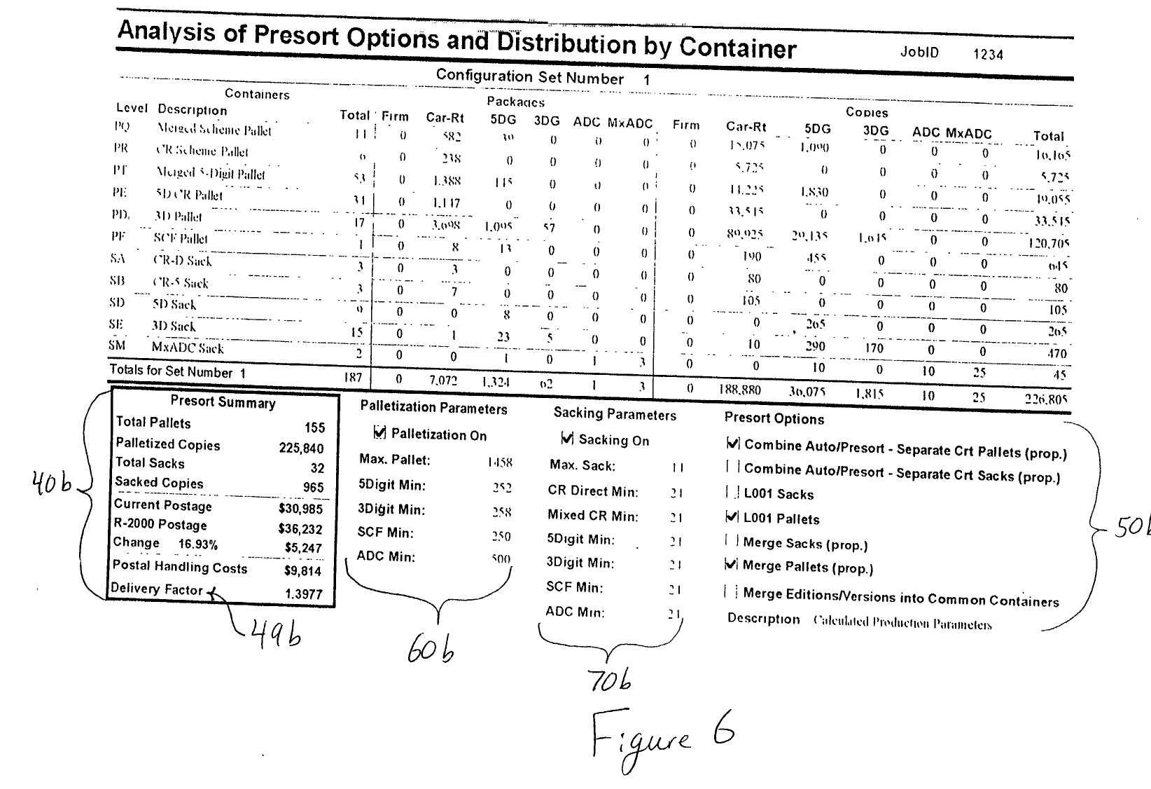

Presort Options 50a confirms the earlier user selections (as shown in FIG. 4) that the user has opted for three of the seven available options as indicated by the check boxes. Palletization On 60a and Sacking On 70a check boxes have also been input by the user via the FIG. 4 GUI. Configuration Set Number 1 result, 80a will be compared with the results illustrated in FIG. 6.

Referring to FIG. 6 another sample analysis output for a different configuration set is illustrated. Note that FIG. 6 reflects an optimum delivery factor. Configuration Set Number 5, 80b, reflects input and results that differ from FIG. 5. Note that none of the check boxes for Presort Options 50b are marked. Further, the user has not checked Palletization On 60b. Sacking On 70b has been marked for Configuration Set 5 as it was for Configuration Set 1. The Presort Summary 40b analysis shows a markedly different result than seen for Configuration Set 1.

Postage costs reflected in FIG. 6 Presort Summary 40b are of the same amount as shown in FIG. 5 Presort Summary 40a. However, the Postal Handling Costs are about 2.5 times as high in FIG. 6 (80b) as they appear in FIG. 5 (80a). The presorting strategy in Set 5 is much more costly to the USPS than the strategy in Set 1. However, the presort postage is identical for each strategy. Note that the Delivery Factor 49b is 1.0000 (relatively optimum factor). This compares favorably to the delivery factor 49a in set 1 (nearly 1.4).

With the present invention users can readily compare the results of differing alternatives, thus optimizing with respect to presort mailing priorities. Those skilled in the art will note that parameters that may be input are not limited to conditions prescribed in the USPS presort and bulk mailing regulations. Other parameters known to those skilled in the art will also be useful. The present invention is designed to allow alternative conditions not currently accepted by the USPS. In this manner, superior strategies that are cost effective can be presented to the USPS for their consideration. Additionally the present invention allows users to play “what if” games with differing mailing strategies before embarking on any specific plan.

Under another embodiment, a “figure of merit” that is an efficiency rating score associated with a specific option set, is determined and published. This figure of merit will provide a performance or cost index relative to an optimal strategy.

A method and apparatus for postal Presort Analyzer has now been illustrated. It will be appreciated by those skilled in the art that other variations of the present invention are possible without departing from the scope of the invention as disclosed.

I claim:

1] A system for analyzing a presort mailing consistent with USPS requirements comprising:
a processor comprising memory;
logic for importing a designated database, said database describing a mailing in a format of a collection of files describing the mailing conforming to a standard for communicating information relating to the composition of a presorted mailing;
a plurality of alternative option sets for presort mailings;
logic for inputting said option sets;
logic for analyzing each option set in combination with the database information such that an analysis for each option set produces a modeled mailing presort and calculates resultant cost and effects;
storage for storing input, imported files and resultant cost and effects; and
logic for presenting said resultant cost and effects.

2] The system of claim [c1] wherein at least one option set comprises parameters not supported by USPS regulations.

3] The system of claim [c1] wherein the presentation of the resultant cost and effects is unique for each option set.

4] The system of claim [c1] further comprising:
logic for identifying packages of mail contained in the imported designated database; and
logic for sorting said packages by container consistent with modeled mailing presort and consistent with the analysis for each option set.

5] The system of claim [c3] further comprising:
logic for computing an optimum presort strategy for the identified packages; and
logic for calculating a figure of merit for the analysis for each option set.

6] The system of claim [c1] wherein said cost comprises a cost to the USPS of processing the presort mailing.

7] The system of claim [c1] wherein said cost comprises a cost of postage for the presort mailing.

8] The system of claim [c1] wherein said cost comprises a cost of processing the presort mailing as incurred in the preparation of the mailing.

9] The system of claim [c1] further comprising logic for calculating an average delivery factor for said modeled mailing presort wherein the average delivery factor represents effects on postal delivery for a presort mailing.

10] The system of claim [c3] wherein the processor further comprises logic for presenting results of the analysis for each option set such that the cost and effects are compared.

11] The system of claim [c2] wherein the processor further comprises logic for presenting resultant cost and effects in a form sufficient for creating a Negotiated Service Agreement between USPS and the mailer.

12] The system of claim [c2] wherein the processor further comprises logic for presenting resultant cost and effects in a form sufficient for creating a Niche Classification agreement between USPS and the mailer.

13] The system of claim [c1] further comprising logic for deriving a presort job file for any of the plurality of option sets of a user's choosing.

14] The system of claim [c13] further comprising logic for formatting the presort job file in a format consistent with the format required by a specific presort program.

15] The system of claim [c1] further comprising logic for deriving a parameter file implicit in the imported database, said parameter file comprising options and parameters used to create the imported database.

16] The system of claim [c1] further comprising:
logic for importing Name and Address Label file of a presort mailing inherent in the imported database;
logic for allowing a user to choose a preferred option set;
logic for sorting the name and address entries in a modeled mailing presort order resulting from the analysis using the preferred option set; and
logic for creating a sorted name and address entries file sufficient for printing mailing labels in the modeled mailing presort order resulting from the analysis using the preferred option set.

17] The system of claim [c1] further comprising:
logic for allowing a user to choose a preferred option set; and
logic for creating a new database, said database consistent with the preferred option set and consistent with presort mailing industry requirements in describing a mailing in a format standard for communicating information relating to the composition of a presorted mailing.

18] The system of claim [c1] further comprising an interface for substituting an actual value parameter for an estimated parameter or an omitted parameter.

19] The system of claim [c18] wherein the actual value parameter is the weight of a mail piece.

20] The system of claim [c18] wherein the actual value parameter is a percentage of advertising contained in a periodical to be mailed.

21] The system of claim [c18] wherein the actual value parameter is a mailing location.

22] The system of claim [c1] wherein the logic for presenting said resultant cost and effects further comprises logic for exporting the resultant cost and effects to a spreadsheet.

23] The system of claim [c1] wherein the logic for presenting said resultant cost and effects further comprises logic for displaying the resultant cost and effects on a display.

24] A method for analyzing a presort mailing consistent with USPS requirements comprising:
importing a designated database, said database describing a mailing in a format of a collection of files describing the mailing conforming to a standard for communicating information relating to the composition of a presorted mailing;
importing a plurality of option sets for presort mailings;
storing said option sets;
analyzing each option set in combination with the database information to produce an analysis for each option set, the analysis comprising modeling a modeled mailing presort and computing the resultant cost and effects; and
presenting said resultant cost and effects.

25] The method of claim [c24] wherein at least one option set of the plurality of option sets comprises parameters not supported by USPS regulations.

26] The method of claim [c24] wherein the presenting of resultant cost and effects are unique for each option set.

27] The method of claim [c24] further comprising:
identifying packages of mail contained in the imported designated database; and
sorting said packages by container consistent with the modeled mailing presort and consistent with the option set incorporated in the analysis.

28] The method of claim 27 further comprising:
computing an optimum presort strategy for the identified packages of mail; and
calculating a figure of merit for the option set incorporated in the analysis.

29] The method of claim [c24] wherein said cost comprises a cost to the USPS of processing the presort mailing.

30] The method of claim [c24] wherein said cost comprises a cost of postage for the presort mailing.

31] The method of claim [c24] wherein said cost comprises a cost of processing the presort mailing as incurred in the preparation of the mailing.

32] The method of claim [c24] wherein said effects comprises an average delivery factor for said mailing

33] The method of claim [c26] wherein the presenting of the resultant cost and effects for the analysis for each option set comprises presenting cost and effects such that a user can compare the results of the analysis for each option set.

34] The method of claim [c25] wherein the presenting of the cost and effects comprises presenting cost and effects such that the resultant cost and effects are used as a basis for a Negotiated Service Agreement between USPS and the mailer.

35] The method of claim [c25] wherein the presenting of cost and effects comprises presenting resultant cost and effects in a form sufficient for creating a basis for a Niche Classification agreement between USPS and the mailer.

36] The method of claim [c24] further comprising creating a presort job file for any option set of a user's choosing.

37] The method of claim [c36] wherein the creating a presort job file comprising creating a file in a format consistent with the format required by a specific presort program of the user's choosing.

38] The method of claim [c24] further comprising deducing options and parameters in an option set inherent in the imported database.

39] The method of claim [c24] further comprising:
importing a Name and Address Label file associated with a presort mailing inherent in the imported database;
a user choosing a preferred option set;
sorting the name and address entries in an modeled mailing presort order resulting from the analysis using the preferred option set; and
creating a sorted name and address entries file sufficient for printing mailing labels in the modeled mailing presort order resulting from the analysis using the preferred option set.

40] The method of claim [c24] further comprising:
a user to choosing a preferred option set; and
creating a new database, said database consistent with the preferred option set and consistent with presort mailing industry requirements in describing a mailing in a format standard for communicating information relating to the composition of a presorted mailing.

41] The method of claim [c24] further comprising substituting an actual value parameter for an estimated parameter or an omitted parameter.

42] The method of claim [c41] wherein the actual value parameter is a weight of a mail piece.

43] The method of claim [c 41] wherein the actual value parameter is a percentage of advertising contained in a periodical to be mailed.

44] The method of claim [c41] wherein the actual value parameter is a mailing location.

45] The method of claim [c24] wherein the presenting said resultant cost and effects comprises exporting said resultant cost and effects to a spreadsheet.

46] The method of claim [c24] wherein the presenting said resultant cost and effects comprises displaying said resultant cost and effects on a display.

47] A system for analyzing a presort mailing consistent with USPS requirements comprising:
a processor comprising memory;
logic for importing a designated database, said database describing a mailing in a format of a collection of files describing the mailing conforming to a standard for communicating information relating to the composition of a presorted mailing;
an option set for presort mailing;
logic for inputting said option set;
logic for analyzing the option set in combination with the designated database such that an analysis for the option set produces a modeled mailing presort and calculates resultant cost and effects;
storage for storing input, imported files and resultant cost and effects; and
logic for presenting said resultant cost and effects.

48] The system of claim [c47] wherein the option set comprises a parameter not supported by USPS regulations.

49] The system of claim [c47] further comprising:
logic for identifying packages of mail contained in the imported designated database; and
logic for sorting said packages by container consistent with modeled mailing presort and consistent with the analysis.

50] The system of claim [c47] further comprising:
logic for computing an optimum presort strategy; and
logic for calculating a figure of merit for the option set incorporated in the analysis.

51] The system of claim [c48] wherein the logic for presenting cost and effects is structured such that the presentation is in a form sufficient for creating a Negotiated Service Agreement between USPS and the mailer.

52] The system of claim [c48] wherein the logic for presenting cost and effects is structured such that the presentation is in a form sufficient for creating a Niche Classification agreement between USPS and the mailer.

53] The system of claim [c49] further comprising:
logic for importing Name and Address Label file of a presort mailing inherent in the imported database;
logic for sorting the name and address entries in a modeled mailing presort order resulting from the analysis; and
logic for creating a sorted name and address entries file sufficient for printing mailing labels in the modeled mailing presort order resulting from the analysis using the option set.

54] The system of claim [c47] further comprising:
logic for creating a new database, said database consistent with the option set and consistent with presort mailing industry requirements in describing a mailing in a format standard for communicating information relating to the composition of a presorted mailing.

55] The system of claim [c47] further comprising an interface for substituting an actual value parameter for an estimated parameter or an omitted parameter.

56] The system of claim [c55] wherein the actual value parameter is the weight of a mail piece.

57] The system of claim [c55] wherein the actual value parameter is a percentage of advertising contained in a periodical to be mailed.

58] The system of claim [c55] wherein the actual value parameter is a mailing location.

59] A method for analyzing a presort mailing consistent with USPS requirements comprising:
importing a designated database, said database describing a mailing in a format of a collection of files describing the mailing conforming to a standard for communicating information relating to the composition of a presorted mailing;
inputting an option set for presort mailings;
storing said option set;
analyzing the option set in combination with the database information such that an analysis produces a modeled mailing presort and a resultant cost and effects; and
presenting said resultant cost and effects.

60] The method of claim [c59] wherein the option set comprises a parameter not supported by USPS regulations.

61] The method of claim [c59] further comprising:
identifying packages of mail contained in the imported designated database; and
sorting said packages by container consistent with modeled mailing presort and consistent with the analysis.

62] The method of claim [c59] further comprising:
computing an optimum presort strategy for the identified packages of mail; and
calculating a figure of merit for the option set incorporated in the analysis.

63] The method of claim [c60] wherein the presenting of the cost and effects comprises presenting cost and effects in a form sufficient for creating a basis for a Negotiated Service Agreement between USPS and the mailer.

64] The method of claim [c60] wherein the presenting of cost and effects comprises presenting cost and effects in a form sufficient for creating a basis for a Niche Classification agreement between USPS and the mailer.

65] The method of claim [c59] further comprising:
importing Name and Address Label file inherent in the imported database;
sorting the name and address entries in the modeled mailing presort order that reflects the analysis; and
creating a sorted name and address entries file sufficient for printing mailing labels in the modeled mailing presort order resulting from the analysis using the option set.

66] The method of claim [c59] further comprising:
creating a new database, said database consistent with the option set and consistent with presort mailing industry requirements in describing a mailing in a format standard for communicating information relating to the composition of a presorted mailing.

67] The method of claim [c59] further comprising substituting an actual value parameter for an estimated parameter or an omitted parameter.

68] The method of claim [c67] wherein the actual value parameter is a weight of a mail piece.

69] The method of claim [c67] wherein the actual value parameter is a percentage of advertising contained in a periodical to be mailed.

70] The method of claim [c67] wherein the actual parameter is a mailing location.
